(19) United States
(12) Patent Application Publication
(10) Pub. No.: US 2016/0207061 A1
(43) Pub. Date: Jul. 21, 2016

(54) LINE MARKING APPARATUS WITH LINE GUIDE

(71) Applicant: DIGITAL LINE MARKERS FZE, Sharjah (AE)

(72) Inventor: Iain PETER MCGUFFIE, Nr. Bromyard (GB)

(73) Assignee: DIGITAL LINE MARKERS FZE, Sharjah (AE)

(21) Appl. No.: 14/392,368

(22) PCT Filed: Jul. 15, 2014
(86) PCT No.: PCT/IB2014/063111

§ 371 Date: Feb. 1, 2016

(30) Foreign Application Priority Data
Jul. 30, 2013 (GB) 1313540.5

(51) Int. Cl. B05B 13/00; B05B 15/04; B05B 9/00

(52) U.S. Cl. CPC B05B 13/005; B05B 9/007; B05B 15/04

(57) ABSTRACT

A line marking apparatus comprises a housing (1) provided with wheels (3), means (5) for propelling the apparatus, and a spray head (9) for delivering line marking material to a surface to be marked. At least one line guide (11) is provided for defining an edge of a line to be marked, the line guide being mounted on an arm (15) which is pivotably mounted relative to the remainder of the apparatus such that the line guide is movable between a deployed configuration and a stored configuration in which the line guide is received in receiving structure (23) formed on the housing.

This invention relates to line marking apparatus with a line guide.

It is common for a line marker to spray between two discs or plates in order to create a line. The relative positions of the discs or plates are generally adjusted by means of a thumb screw or a spanner, or the discs may travel along a threaded bar to adjust the distance between them. The spacing can be pre-determined by location holes which receive a stop, such as a peg, to maintain the position of the discs or plates, or in the case of more sophisticated apparatus the discs or plates are screwed together or apart and can move both towards each other and away from each other under a single control mechanism. A problem with these known line guides is that they are complicated and costly to manufacture. Moreover, they do not readily cope with a wide range of adjustment, for example from 25 mm to 200 mm or more, with substantially infinite adjustment within that range. Moreover, the line guide assemblies are difficult to store and, more especially, to transport because the assemblies protrude from the line marking apparatus and can therefore easily be damaged or difficult to fit within restricted transportation space, such as the boot of a car. If the line guide assembly is separable from the line marking apparatus for storage and transportation purposes, then the line guide assembly can be mislaid.

It is therefore an object of the present invention to provide a line marking apparatus with a line guide which overcomes, or at least ameliorates, the above problems.

According to the present invention there is provided a line marking apparatus comprising a housing provided with wheels, means for propelling the apparatus, and a spray head for delivering line marking material to a surface to be marked, the apparatus further comprising at least one line guide for defining an edge of a line to be marked, the line guide being mounted on an arm which is pivotably mounted relative to the remainder of the apparatus such that the line guide is movable between a deployed configuration and a stored configuration in which the line guide is received in receiving structure formed on the housing.

The line guide may be provided with a stub axle which passes through the arm in the region of the free end thereof.

The stub axle may be adjustable in the axial direction thereof (for example, in a direction perpendicular to the axial direction of the arm). For example, the stub axle may be threaded within the arm or the stub axle may be secured in any one of a number of different positions by means of pegs positioned each side of the arm and passing through holes formed through the stub axle. As a further alternative, the stub axle may be secured in position by means of a spring-loaded collar positioned in an open slot formed in the end of the arm, the spring-loaded collar passing around the stub axle and having manually-operable levers to release the collar by increasing the diameter thereof and to permit re-positioning of the stub axle and line guide, with the collar gripping the stub axle when the manually-operable levers are released. According to another alternative, a threaded member provided with means for rotating the same may pass through the arm so as to releasably lock the stub axle and the arm.

The other end of the arm may be rotatably mounted to an axle for one of the wheels of the apparatus. Alternatively, the other end of the arm may be pivotably mounted at a suitable location on the housing. That end of the stub axle remote from the line guide may be provided with a handle for use in adjusting the position of the stub axle and therefore of the line guide. Where the line guide is in the form of a disc, the line guide may be rotatably mounted about its axis on the stub axle.

The receiving structure may be in the form of a recess formed in the housing, such as in a side thereof. The recess may be configured to receive all or part (such as a lower part) of the line guide. Alternatively, the receiving structure may be in the form of a flange protruding from the housing and configured to extend around all or part of the periphery of the line guide. Thus, for a line guide in the form of a disc, the flange may be cylindrical.

A stop may be provided for limiting downward pivoting movement of the line guide. The stop may engage with an underside of the arm.

The means for propelling the apparatus may comprise a handle.

The spray head may extend forwardly from the housing in use but may be retractable into the housing when the line marking apparatus is being transported or stored.

Two line guides may be provided, one line guide being deployed in use on each side of the spray head.

The line guide may be in the form of a disc. Alternatively, the line guide may be in the form of a plate.

For a better understanding of the present invention and to show more clearly how it may be carried into effect reference will now be made, by way of example, to the accompanying drawings in which:

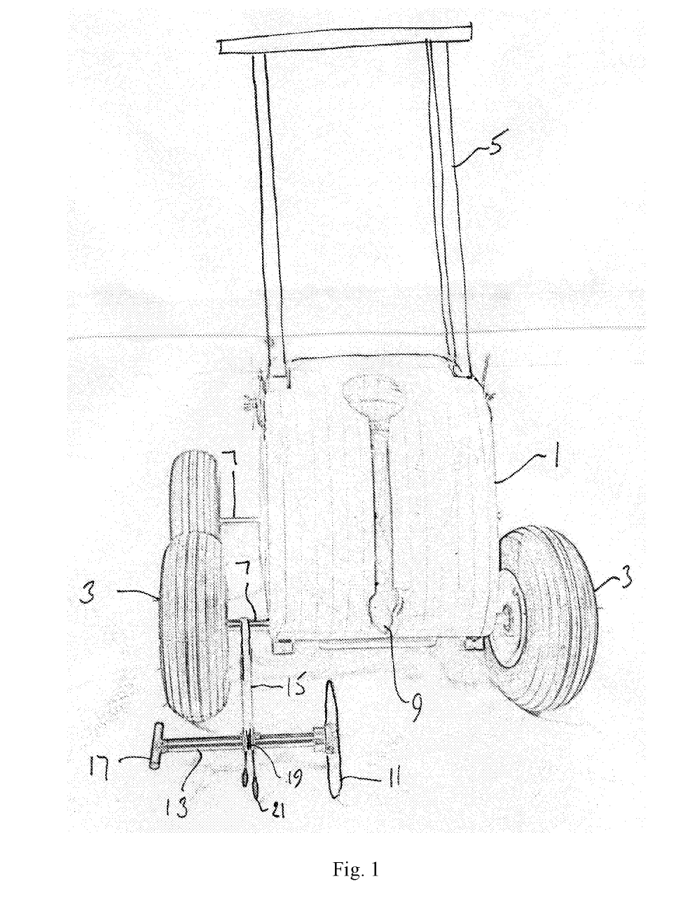

FIG. 1 is a view of one embodiment of part of a line marking apparatus provided with a line guide assembly according to the present invention in a first configuration;

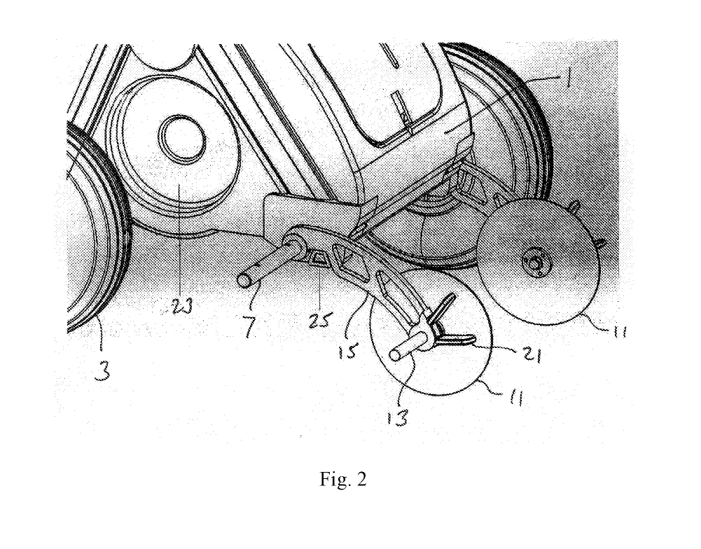

FIG. 2 is a view of a part of a line marking apparatus with a modified line guide compared with that of FIG. 1; and

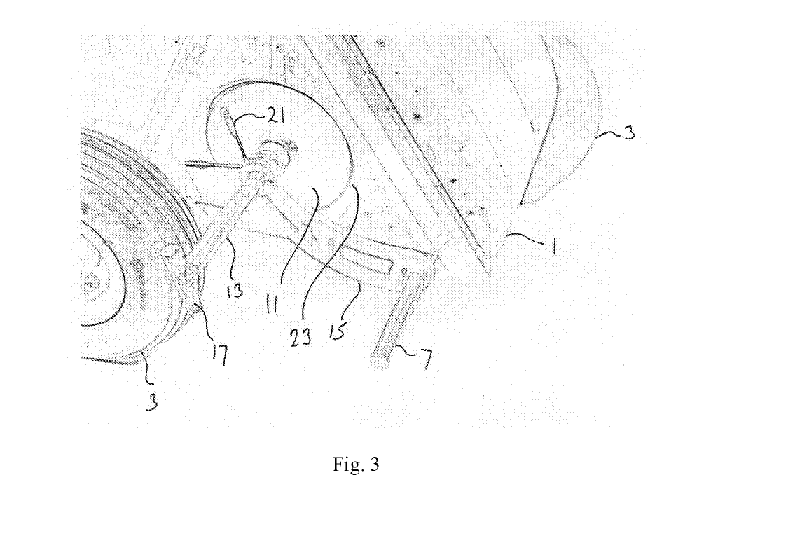

FIG. 3 is a view of the line marking apparatus of FIG. 1 with the line guide assembly in a second configuration.

The line marking apparatus shown in the figures comprises a housing 1 provided with wheels 3 and a handle 5. The wheels 3 are mounted on axles 7. A spray head 9 for delivering line marking material to a surface to be marked extends forwardly from the housing 1, but may be retractable into the housing when the line marking apparatus is being transported or stored.

A line guide 11, in the form of a disc, is provided with a stub axle 13 which passes through an arm 15 in the region of the free end thereof. The line guide serves to define an edge of a line to be marked. The other end of the arm 15 is rotatably mounted to the axle 7 at one side of the housing 1 which supports one of the front wheels 3 of the line marking apparatus. Alternatively, the other end of the arm may be pivotably mounted at a suitable location on the housing 1. That end of the stub axle 13 remote from the line guide 11 may optionally be provided with a handle 17 for use in adjusting the position of the stub axle and therefore of the line guide. Only a single line guide is shown in the FIGS. 1 and 3 for clarity, but in practice a complementary line guide would be mounted to the axle 7 at the other side of the housing 1 which supports the other of the front wheels of the line marking apparatus. The line guide may alternatively be in the form of a plate rather than a disc, but a disc has the advantage that it can be rotatably mounted about its axis on the stub axle 13 with the result that the line guide rolls across the surface to be marked rather than being pushed along the surface. Rolling gives rise to less wear and tear on both the line guide and the surface.

The stub axle 13 is adjustable in the axial direction thereof (that is, in a direction perpendicular to the axial direction of the arm 15). In this way the two line guides can be adjusted towards and away from each other to determine the width of a line to be marked. The line guides may be movable towards and away from each other in the traditional manner. For example, the stub axle may be threaded within the arm 15 or the stub axle may be secured in any one of a number of different positions by means of pegs positioned each side of the arm 15 and passing through holes formed through the stub axle. As a further alternative, the stub axle 13 may be secured in position by means of a spring-loaded collar 19 positioned in an open slot formed in the end of the arm 15, the spring-loaded collar passing around the stub axle and having manually-operable levers 21 to release the collar by increasing the diameter thereof and to permit re-positioning of the stub axle and line guide, with the collar gripping the stub axle when the manually-operable levers are released. A similar effect can be achieved with a threaded member which passes through the end of the arm 15 and is provided with means for rotating the same so as to releasably lock the stub axle 13 and the arm 15.

The rotatable mounting of the arm 15 on the axle 7 allows the line guides to rise and fall to adapt to irregularities in the surface being marked. The rotatable mounting also allows the line guides 11 to be re-positioned during transportation and storage of the line marking apparatus. This is illustrated in FIG. 2 in which the front wheel 3 has been omitted for clarity. The housing 1 is formed with a receiving structure in the form of a recess 23 in each side thereof, the recess being dimensioned to receive one of the line guides 11. For storage and transportation, the line guide 11 can be moved outwardly such that the arm 15 is able to rotate and the line guide is able to align with the corresponding recess. The line guide is then moved inwardly into the recess and locked in position until it is required to be deployed. This has the advantages of minimising the risk of damage to the line guides, reducing the footprint of the line marking apparatus for transportation purposes, and also storing the line guides in a position in which any remaining line marking material is unlikely to contact the boot of a vehicle or other storage or transportation environment.

The receiving structure may have other configurations. For example, the receiving structure may be in the form of a flange protruding from the housing and configured to extend around all or part of the periphery of the line guide 11. Thus, for a line guide in the form of a disc, the flange may be cylindrical. As a further alternative, the receiving structure may be in the form of a recess which is configured to accept only part of the line guide, ideally the lower part of the line guide in use.

Thus the line guide is movable between a deployed configuration in which the line guide is positioned to one side of the line marking head and a stored position in which the line guide is received in the receiving structure formed on the housing.

Should an operator lift the front of the apparatus (as by tilting the handle backwards when crossing a marked line or when moving from one location to another) then the line guide of FIGS. 1 and 3 would continue to drop and would not readily lift of the surface being marked. This impedes manoeuvring of the apparatus and can result in unwanted line marking material being deposited on the surface. A stop 25 is therefore provided which engages with the underside of the arm to limit downward movement of the line guides, for example to 15 degrees below the plane on which the apparatus is moving.)

1. A line marking apparatus comprising a housing (1) provided with wheels (3), means (5) for propelling the apparatus, and a spray head (9) for delivering line marking material to a surface to be marked, the apparatus further comprising at least one line guide (11) defining an edge of a line to be marked, the line guide being mounted on an arm (15) which is pivotably mounted relative to the reminder of the apparatus such that the line guide is movable between a deployed configuration and a stored configuration in which the line guide is received in receiving structure (23) formed on the housing.

2. An apparatus as claimed in claim 1, wherein the line guide (11) is provided with a stub axle (13) which passes through the arm (15) in the region of the free end thereof.

3. An apparatus as claimed in claim 2, wherein the stub axle (13) is adjustable in the axial direction thereof.

4. An apparatus as claimed in claim 3, wherein the stub axle (13) is threaded within the arm (15).

5. An apparatus as claimed in claim 3, wherein the stub axle (13) is secured in any one of a number of different positions by means of pegs positioned each side of the arm (15) and passing through holes formed through the stub axle.

6. An apparatus as claimed in claim 3, wherein the stub axle (13) is secured in position by means of a spring-loaded collar (19) positioned in an open slot formed in the end of the arm, the spring-loaded collar passing around the stub axle and having manually-operable levers (21) to release the collar by increasing the diameter thereof and to permit re-positioning of the stub axle and line guide (11), with the collar gripping the stub axle when the manually-operable levers are released.

7. An apparatus as claimed in claim 3, wherein a threaded member provided with means for rotating the same passes through the arm (15) so as to releasably lock the stub axle (13) and the arm (15).

8. An apparatus as claimed in claim 2, wherein the other end of the arm (15) is rotatably mounted to an axle (7) for one of the wheels (3) of the apparatus.

9. An apparatus as claimed in claim 2, wherein the other end of the arm (15) is pivotably mounted at a suitable location on the housing (1).

10. An apparatus as claimed in claim 2, wherein that end of the stub axle (13) remote from the line guide (11) is provided with a handle (17) for use in adjusting the position of the stub axle and therefore of the line guide.

11. An apparatus as claimed in claim 2, wherein the line guide (11) is in the form of a disc, and wherein the line guide is rotatably mounted about its axis on the stub axle (13).

12. An apparatus as claimed in claim 1, wherein the receiving structure (23) is in the form of a recess formed in the housing (1).

13. An apparatus as claimed in claim 12, wherein the recess (23) is formed in a side of the housing (1).

14. An apparatus as claimed in claim 12, wherein the recess (23) is configured to receive all of the line guide (11).

15. An apparatus as claimed in claim 12, wherein the recess (23) is configured to receive part of the line guide (11).

16. An apparatus as claimed in claim 15, wherein the recess (23) is configured to receive a lower part of the line guide (11).

17. An apparatus as claimed in claim 1, wherein the receiving structure (23) is in the form of a flange protruding from the housing and configured to extend around all or part of the periphery of the line guide (11).

18. An apparatus as claimed in claim 17, wherein the line guide (11) is in the form of a disc, and wherein the flange (23) is cylindrical.

19. An apparatus as claimed in claim 1, wherein a stop (25) is provided for limiting downward pivoting movement of the line guide (11).

20. (canceled)

21. (canceled)

22. An apparatus as claimed in claim 1, wherein the spray head (9) extends forwardly from the housing (1) in use but is retractable into the housing for transportation or storage of the line marking apparatus.

23. An apparatus as claimed in claim 1, wherein two line guides (11) are provided, one line guide being deployed in use on each side of the spray head (9) and defining opposite edges of the line to be marked.

24. (canceled)

25. (canceled)
